(19) United States
(12) Patent Application Publication
(10) Pub. No.: US 2026/0361676 A1
(43) Pub. Date: Nov. 12, 2026

(54) Enhanced IoT Ecosystems with Decentralized Gateway Solutions

(71) Applicant: Silicon Laboratories Inc., Austin, TX (US)

(72) Inventors: Sagar Chinchani, Braintree, MA (US); Michael Moccia, Boston, MA (US)

(21) Appl. No.: 19/204,953

(22) Filed: May 12, 2025

(51) Int. Cl. H04L 61/106; H04L 12/66; H04L 61/255; H04L 101/622

(52) U.S. Cl. CPC H04L 61/106; H04L 12/66; H04L 61/255; H04L 2101/622

(57) ABSTRACT

A system and method for use in a multi-network environment, that allows devices, other than the gateway, to serve as the proxy for network devices on a different network. The gateway identifies multi-protocol network devices, which are devices that communicate on two different networks. The gateway then transfers at least one entry from a mapping table to the multi-protocol network device, which allows the multi-protocol network device to serve as a proxy for at least one network device. This may relieve congestion in the gateway and eliminate the single point of failure associated with these multi-network environments.

### FIELD

This disclosure describes systems and methods for improving the robustness of IoT ecosystems with multiple network protocols.

### BACKGROUND

The Internet of Things (IoT) has led to an explosion in the number of network devices that are available. In some environments, these network devices may support different network protocols. For example, a home network may include both Zigbee and Thread/Matter devices. To allow network devices belonging to different networks to communicate, a gateway is often used. In certain embodiments, these different networks are each a mesh network.

FIG. 1 shows one such environment. In this environment, there are two network devices 1, 2 that belong to a first network (shown in shading) and communicate using a first network protocol. Additionally, there are two network devices 3, 4 that belong to a second network and communicate using a second network protocol. When network device 1 wants to communicate with network device 2, it simply transmits the desired packet to that network device using the first network protocol. However, if network device 1 wants to communicate with network device 3, a more complicated process is used.

Specifically, a multi-network gateway 5 is used to bridge between these two networks. The multi-network gateway 5 may have a first address (0x22222222) used by the first network that represents its actual network address on that network. The multi-network gateway 5 may also have additional virtual addresses (0x33333333, 0x44444444) that are used by the first network. These virtual addresses represent network device 3 and network device 4, respectively, which are located on the second network. Further, the multi-network gateway 5 includes an address (0x34567890) that is used by the second network and represents its actual address. The multi-network gateway 5 also includes two virtual addresses (0x45678901, 0x56789012) that are used by the second network. These virtual addresses represent network device 1 and network device 2, which are located on the first network. Thus, when network device 1 wants to communicate with network device 3, it uses the virtual address (0x33333333) provided by the multi-network gateway 5 as the destination address and its own address (0x00000000) as the source address. The multi-network gateway 5 receives this packet and forwards it to the network device 3. When the multi-network gateway 5 forwards the packet to the network device 3, it uses one of the virtual addresses (0x45678901) as the source address and the actual address of network device 3 as the destination address. When the network device 3 responds, it uses its own address (0x12345678) as the source address and the virtual address (0x45678901) as the destination address. The multi-network gateway 5 then forwards the packet back to the network device 1, using the address of the network device 1 (0x00000000) as the destination address and the virtual address associated with the network device 3 (0x33333333) as the source address.

In other words, the multi-network gateway 5 exposes the devices from different networks to each other by pretending to be one or more of the devices. For example, assume that the first network is Zigbee and the second network is Thread/Matter. On the Zigbee network, the multi-network gateway 5 advertises the existence of device 0x33333333, which represents a Thread/Matter device, which may be a light. The multi-network gateway 5 will act as a proxy to route messages targeted for 0x33333333 to Thread/Matter Light 0x12345678. On the Thread/Matter network, the multi-network gateway 5 advertises the switch as device 0x45678901, which is actually Zigbee Switch 0x11111111. Any messages targeted for 0x45678901 will be proxied to the Zigbee Switch 0x00000000 by the multi-network gateway 5. This configuration requires the multi-network gateway 5 to maintain a mapping table, such as the one shown in FIG. 2. In FIG. 2, the asterisks indicate a virtual address that is assigned by the multi-network gateway 5. Note that in some embodiments, the mapping table may also include the function of each network device.

To remove the complexity of these networks, in certain embodiments, a network device may be designed to operate on two different network and therefore have two addresses, each associated with a different network protocol. FIG. 3 shows the environment of FIG. 1 with an additional multi-protocol network device 6. This multi-protocol network device 6 differs from the multi-network gateway 5 in that it typically does not have the processing power or storage of the multi-network gateway 5. Further, it typically does not include any additional network connections, such as a connection to the internet via a third network interface. Additionally, the multi-protocol network device 6 also includes another function, which may be a line-powered application supported by the mesh networks, such as a light, an actuator, such as a switch, motor, or other similar device, or a sensor. Thus, when accessed by a device on the first network, the multi-protocol network device 6 utilizes an address of 0x55555555 (shown in shading). Likewise, when accessed by a device on the second network, the multi-protocol network device 6 utilizes an address of 0x67890123.

The inclusion of the multi-protocol network device 6 may simplify the operation of the multi-network gateway 5, since it does not need to create an entry in the mapping table of the multi-network gateway 5.

However, in these environments, the multi-network gateway 5 can become a bottleneck, with all data transmissions between different networks requiring passage through the multi-network gateway 5. This centralization poses a risk of a single point of failure, potentially compromising the entire network if the gateway fails. Further, to avoid slowing the network, the processing power and the memory capacity of the gateway may be significant, resulting in a more expensive device.

Therefore, it would be beneficial if there was a system and method to offload some of the tasks that are currently performed by the multi-network gateway. Further, it would be advantageous if this offloading may be performed using devices that are currently in the environment.

### SUMMARY

A system and method for use in a multi-network environment, that allows network devices, other than the gateway, to serve as the proxy for network devices on a different network. The gateway identifies multi-protocol network devices, which are devices that communicate on two different networks. The gateway then transfers at least one entry from a mapping table to the multi-protocol network device, which allows the multi-protocol network device to serve as a proxy for at least one network device. This may relieve congestion in the gateway and eliminate the single point of failure associated with these multi-network environments.

According to one embodiment, a method of managing a system comprising two networks comprising different network protocols, wherein there is a first network device on a first network and a second network device on a second network, is disclosed. The method comprises using a multi-network gateway to create a mapping table, wherein the mapping table comprises an entry for the first network device, which comprises a first actual address used by the first network and a first virtual address used by the second network; and an entry for the second network device, which comprises a second actual address used by the second network and a second virtual address used by the first network; identifying, by the multi-network gateway, at least one additional device that comprises a multi-protocol network device, which has an actual address on the first network and an actual address on the second network; transferring at least one entry of the mapping table to the multi-protocol network device; receiving, at the multi-protocol network device, a packet from the first network device on the first network having a destination address that comprises the second virtual address that represents the second network device on the second network, updating the destination address to the second actual address based on the at least one entry and forwarding the packet on the second network. In some embodiments, each entry in the mapping table comprises a function of each network device. In some embodiments, the multi-protocol network device is identified by the multi-network gateway based on a Media Access Control (MAC) address received on the first network and the second network. In some embodiments, the multi-protocol network device is identified by the multi-network gateway using vendor unique commands. In some embodiments, the multi-protocol network device uses a source address provided by the first network device in the packet transmitted on the second network. In some embodiments, the multi-protocol network device creates a virtual address, different from the first virtual address, to use as a source address in the packet transmitted on the second network. In some embodiments, the multi-protocol network device uses the first virtual address as a source address in the packet transmitted on the second network. In certain embodiments, the multi-network gateway transfers both entries in the mapping table to the multi-protocol network device. In certain embodiments, the mapping table comprises additional entries, and the additional entries are not transferred to the multi-protocol network device. In certain embodiments, the mapping table comprises additional entries, and the additional entries are transferred to the multi-protocol network device and the multi-protocol network device only forwards packets assigned to a subset of the mapping table.

According to another embodiment, a system comprises a first network and a second network is disclosed. The system comprises a multi-network gateway that operates on the first network and the second network; and a multi-protocol network device that operates on the first network and the second network; wherein the multi-network gateway is configured to: query the first network to find network devices on the first network; query the second network to find network devices on the second network; create a mapping table wherein each entry in the mapping table comprises an actual address of a network device and a virtual address for the network device; identify the multi-protocol network device; and transmit at least one entry from the mapping table to the multi-protocol network device; and wherein the multi-protocol network device is configured to: receive the at least one entry from the multi-network gateway; receive a packet from a first network device on the first network having a destination address that comprises the virtual address contained in the entry that represents a second network device on the second network; update the destination address to the actual address based on the at least one entry; and forward the packet on the second network. In some embodiments, each entry in the mapping table comprises a function of each network device. In some embodiments, the multi-protocol network device is identified by the multi-network gateway based on a Media Access Control (MAC) address received on the first network and the second network. In some embodiments, the multi-protocol network device uses a source address provided by the first network device in the packet transmitted on the second network. In some embodiments, the multi-protocol network device creates a virtual address, different from the virtual address in the mapping table, to use as a source address in the packet transmitted on the second network. In some embodiments, the multi-protocol network device uses the virtual address in the mapping table as a source address in the packet transmitted on the second network. In certain embodiments, the mapping table comprises an entry for the first network device and an entry for the second network device and the multi-network gateway transfers both entries in the mapping table to the multi-protocol network device. In certain embodiments, the mapping table comprises additional entries, and the additional entries are not transferred by the multi-network gateway to the multi-protocol network device. In certain embodiments, the mapping table comprises additional entries, and the additional entries are transferred by the multi-network gateway to the multi-protocol network device and the multi-protocol network device only forwards packets assigned to a subset of the mapping table. In some embodiments, the multi-protocol network device also comprises a line-powered application.

### BRIEF DESCRIPTION OF THE DRAWINGS

For a better understanding of the present disclosure, reference is made to the accompanying drawings, in which like elements are referenced with like numerals, and in which:

FIG. 1 shows an illustration of an environment with multiple networks and a multi-network gateway;

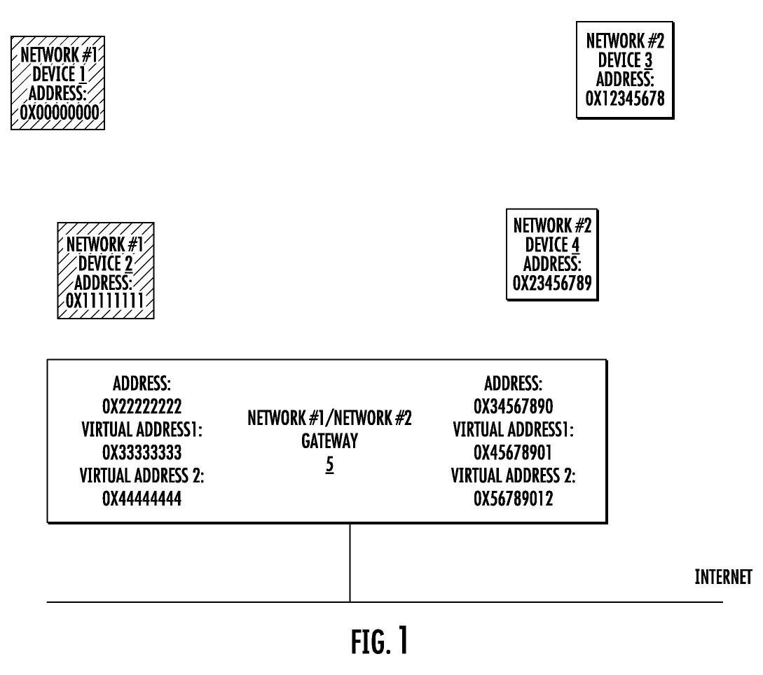

FIG. 2 shows a mapping table contained within the multi-network gateway according to one embodiment;

FIG. 3 shows an illustration of an environment with multiple networks, a multi-protocol network device and a multi-network gateway according to one embodiment;

FIG. 4 shows a block diagram of a multi-protocol network device that implements the improvements described herein;

FIG. 5 shows an illustration of an environment with multiple networks, a multi-protocol network device that includes a mapping table, and a multi-network gateway according to one embodiment;

FIG. 6 shows the software architecture of the multi-protocol network device according to one embodiment;

FIG. 7 shows an illustration of an environment with multiple networks, a multi-protocol network device that includes an entry in the mapping table, and a multi-network gateway according to one embodiment; and

FIGS. 8A-8C show a mapping table contained within the multi-network gateway and two possible mapping tables contained within the multi-protocol network device, respectively, according to one embodiment.

### DETAILED DESCRIPTION

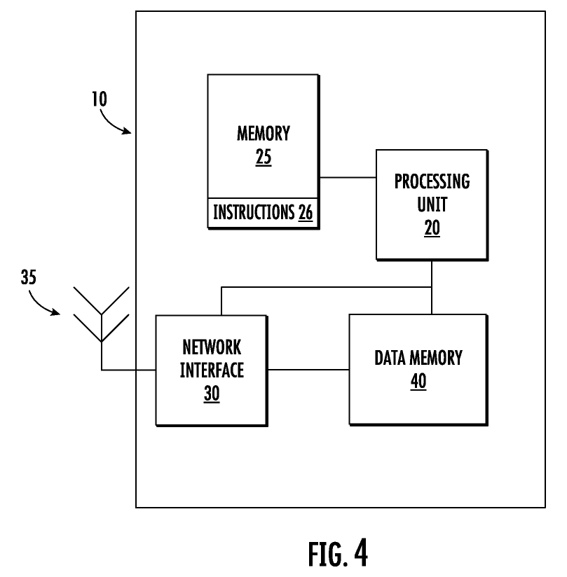

FIG. 4 shows a block diagram of a representative multi-protocol network device 10 that is able to offload some functions from a multi-network gateway.

The multi-protocol network device 10 has a processing unit 20 and an associated memory device 25. The processing unit 20 may be any suitable component, such as a microprocessor, embedded processor, an application specific circuit, a programmable circuit, a microcontroller, or another similar device. This memory device 25 contains the instructions 26, which, when executed by the processing unit 20, enable the multi-protocol network device 10 to perform the functions described herein. This memory device 25 may be a non-volatile memory, such as a FLASH ROM, an electrically erasable ROM or other suitable device. In other embodiments, the memory device 25 may be a volatile memory, such as a RAM or DRAM.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions may be written in any programming language, which is not limited by this disclosure. Thus, in some embodiments, there may be multiple computer readable non-transitory media that contain the instructions described herein. The first computer readable non-transitory media may be in communication with the processing unit 20, as shown in FIG. 4. The second computer readable non-transitory media may be a CDROM, or a different memory device, which is located remote from the multi-protocol network device 10. The instructions contained on this second computer readable non-transitory media may be downloaded onto the memory device 25 to allow execution of the instructions by the multi-protocol network device 10.

The multi-protocol network device 10 also includes a network interface 30, which may be a wireless interface that connects with an antenna 35. The network interface 30 may support two or more suitable networks, such as WiFi, Bluetooth, ZigBee, Thread, and other networks. These two or more suitable networks may be mesh networks. The network interface 30 includes a transmit circuit which is used to transmit data from this multi-protocol network device 10 using the antenna 35. The network interface 30 also includes a receive circuit which is used to receive packets from any of the plurality of networks.

The multi-protocol network device 10 may include a data memory device 40 in which data that is received and transmitted by the network interface 30 is stored. This data memory device 40 is traditionally a volatile memory. The processing unit 20 has the ability to read and write the data memory device 40 so as to communicate with the other nodes in the wireless networks.

Although not shown, the multi-protocol network device 10 may also include a line-powered application which is supported by the network protocols that it supports. This line-powered application may be a light, a switch, or some other function. Although not shown, the multi-protocol network device 10 also has a power supply, which may be a battery or a connection to a permanent power source, such as a wall outlet.

While the processing unit 20, the memory device 25, the network interface 30, and the data memory device 40, are shown in FIG. 4 as separate components, it is understood that some or all of these components may be integrated into a single electronic component. Rather, FIG. 4 is used to illustrate the functionality of the multi-protocol network device 10, not its physical configuration.

As noted above, the multi-protocol network device 10 supports two or more network protocols, which may be mesh networks. Thus, the software contained in the memory device 25 may include two or more software network stacks, each of which is responsible for maintaining the connections with its respective network. Further, each software network stack has a network address which is unique to that network protocol. Thus, in operation, the multi-protocol network device 10 may have two or more concurrent network connections, over two or more different network protocols. In certain embodiments, the two software network stacks may operate completely independently of each other. In one embodiment, one software network stack supports Zigbee, while the second software network stack supports Thread/Matter.

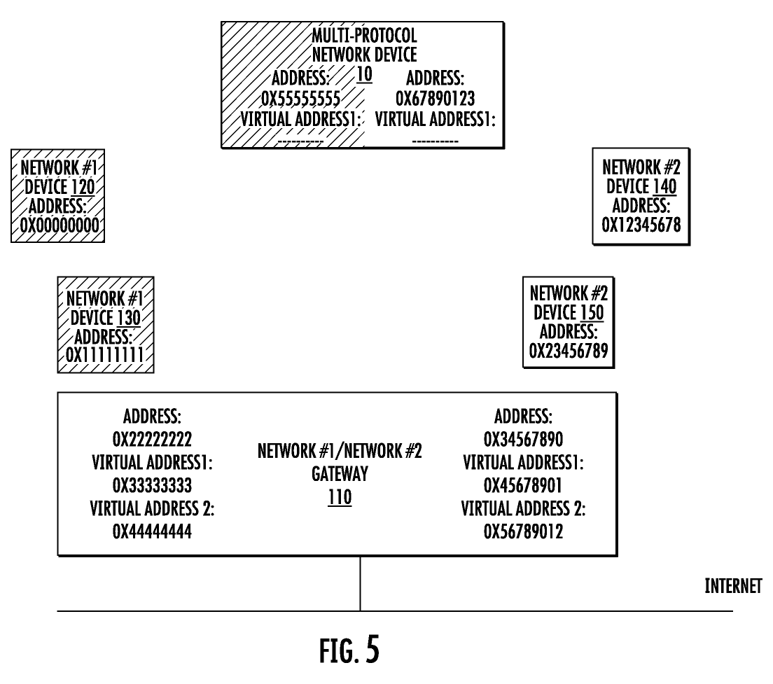

FIG. 5 shows an environment that includes several network devices 120, 130 operating on a first network (shown in shading), several network devices 140, 150 operating on a second network, a multi-network gateway 110, and a multi-protocol network device 10. Note that the multi-network gateway 110 may have a similar architecture to that shown in FIG. 4, but may have a more advanced processing unit, more memory and more network connections. For example, the multi-network gateway 110 may also provide access to the internet for the first network and the second network. Furthermore, the multi-protocol network device 10 differs from the multi-network gateway 110 in that it typically does not have the processing power or storage of the multi-network gateway 110. Further, it typically does not include any additional network connections, such as a connection to the internet via a third network interface. Additionally, the multi-protocol network device 10 also includes another function, which may be a line-powered application supported by the mesh networks, such as a light, an actuator, such as a switch, motor, or other similar device or a sensor. Additionally, the network devices 120-150 may also have a similar architecture to that shown in FIG. 4, but only include a single software network stack.

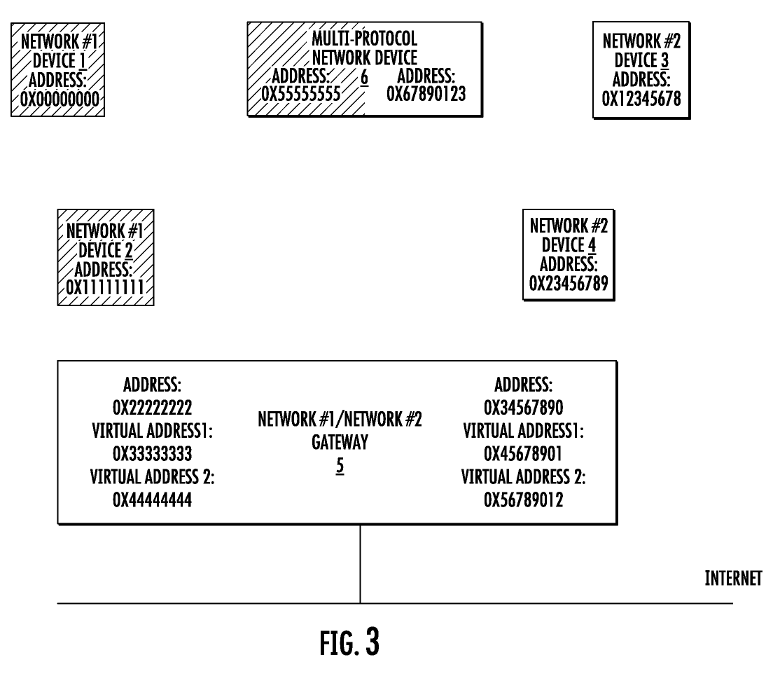

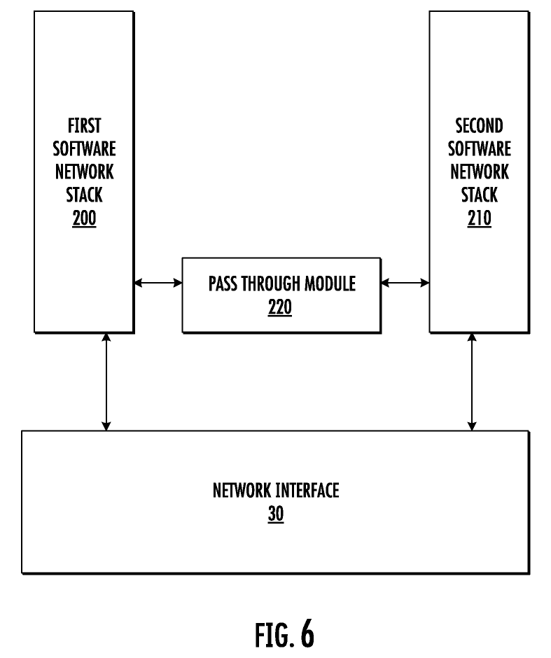

However, unlike the environment shown in FIG. 3, the multi-protocol network device 10 of FIG. 5 has the capability to forward packets from the first network to the second network. Specifically, as shown in FIG. 6, the multi-protocol network device 10 includes a first software network stack 200, a second software network stack 210, and a pass through module 220, which interfaces with both software network stacks. All of these components are software instructions, which are contained within a non-transitory storage medium, such as the memory device 25. As noted above, the first software network stack 200 and the second software network stack 210 are configured to allow two concurrent network connections. The pass through module 220 has the ability to accept packets received by one of the software network stacks and move those packets to the other software network stack for transmission. In the process of moving these packets, the pass through module 220 reformats the packet from the format used by the first network to the format used by the second network. In addition, the pass through module 220 changes the source and destination addresses of the packet, as described in more detail below.

At initialization, the multi-network gateway 110 queries the first network to discover any devices on that network. During this process, the multi-network gateway 110 discovers network device 120 (address: 0x00000000), network device 130 (address:0x11111111) and multi-protocol network device 10 (address:0x55555555). The multi-network gateway 110 then queries the second network to discover any devices on that network. During this process, the multi-network gateway 110 discovers network device 140 (address: 0x12345678), network device 150 (address:0x23456789) and multi-protocol network device 10 (address:0x67890123).

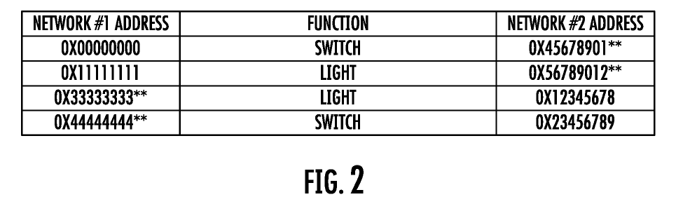

The multi-network gateway 110 then creates virtual addresses that allow network devices on the first network to communicate with network devices on the second network. Thus, as explained above, it creates two virtual addresses on each network and populates this information in the mapping table shown in FIG. 2.

At this time, or at an earlier time, the multi-network gateway 110 determines that address:0x55555555 on the first network and address:0x67890123 on the second network represent the same device; multi-protocol network device 10. This may be done by noting that the Media Access Control (MAC) address associated with address:0x55555555 on the first network and the MAC address associated with address:0x67890123 on the second network are identical. Alternatively, there may be a vendor unique command that is transmitted to the device on one or both of the networks to determine whether it is a multi-protocol network device. The multi-network gateway 110 may then query the multi-protocol network device 10 to determine whether it supports acting as a proxy for one or more devices. Again, this may be done using a vendor unique command transmitted on one or both of the networks.

If the multi-protocol network device 10 responds affirmatively, the multi-network gateway 110 may transfer one or more mappings to the multi-protocol network device 10. In some embodiments, if there are multiple multi-protocol network devices that support acting as a proxy, the multi-network gateway 110 may use routing tables or diagnostic messages to determine which one of these multi-protocol network devices it should select as the proxy. Once the multi-network gateway 110 determines which multi-protocol network device 10 will serve as the proxy, it configures that multi-protocol network device. Specifically, the multi-network gateway 110 transmits a configuration message to the selected multi-protocol network device 10. The configuration message is built upon the Data Model concept, as defined by the Connectivity Standards Alliance specification, and is defined as a custom cluster extension. The configuration message is called the ConfigureTrafficProxyMappingRequest. This ConfigureTrafficProxyMappingRequest configuration message may contain:
The virtual network address of the network device that the multi-protocol network device will serve as the proxy for (referred to as the mapped network device);
The network ID of the source network (which is the network which the mapped network device is not part of);
The actual network address of the mapped network device to be used on the forwarding network; and
The network ID of the forwarding network (which is the network that the mapped network device is part of).

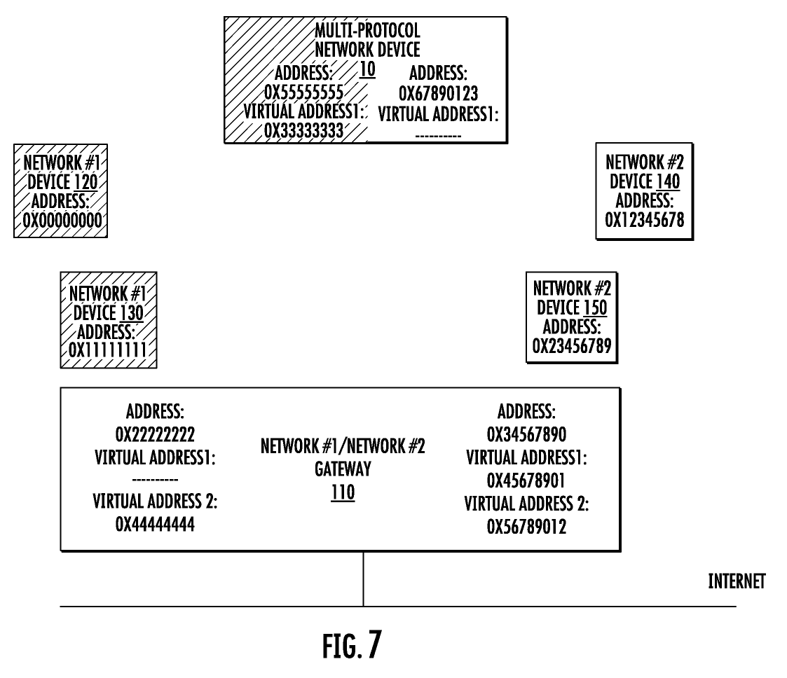

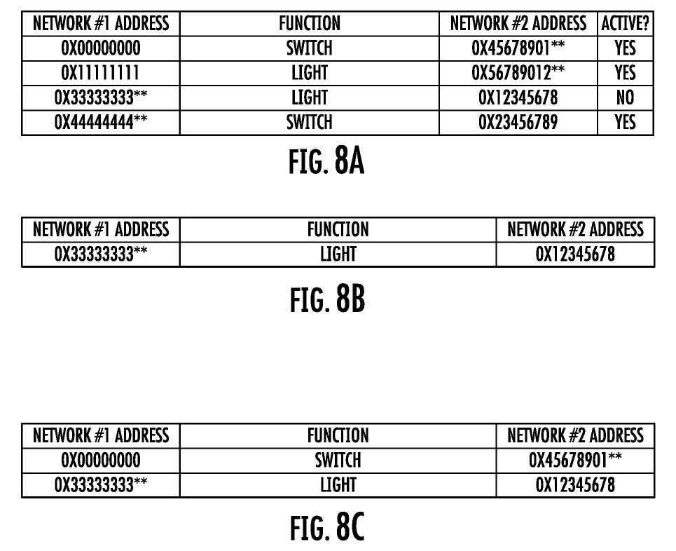

In some embodiments, the multi-protocol network device 10 may inform the multi-network gateway 110 of how many mappings it is able to perform. FIG. 7 shows an embodiment where the multi-network gateway 110 has transferred one mapping to the multi-protocol network device 10. Thus, the multi-protocol network device 10 now responds to one additional address on the first network, which is the virtual address that was previously created by the multi-network gateway 110 and is denoted as Virtual Address1:0x33333333. The mappings associated with the multi-network gateway 110 and the multi-protocol network device 10 are shown in FIGS. 8A and 8B, respectively. Note that the multi-protocol network device 10 is not able to create a mapping table. Rather, it is only able to accept entries that were already created by the multi-network gateway 110. Note that the multi-network gateway 110 may retain the details of the mapping that it transferred to the multi-protocol network device 10, which is shown in FIG. 8A, in case that multi-protocol network device goes offline. The multi-protocol network device 10 now monitors the first network for the address 0x33333333. When this address is present on the first network, the multi-protocol network device 10 receives the message. The pass through module 220 of the multi-protocol network device 10 then moves this message from the first software network stack 200 to the second software network stack 210. The pass through module 220 replaces the destination address (which was 0x33333333) with the actual address of the network device on the second network, which is 0x12345678, as defined in the mapping shown in FIG. 8B. The pass through module 220 may also change the source address contained in the forwarded message. In the original message, the source address was the address of the sending network device (0x00000000) on the first network. In some embodiments, the pass through module 220 simply keeps the source address unchanged.

In a second embodiment, where there is only unidirectional communications between these devices, the pass through module 220 may create a new virtual address to use as the source address. This new virtual address may differ from that assigned by the multi-network gateway 110. The pass through module 220 then changes this source address to this new virtual address on the second network.

In a third embodiment, the multi-network gateway 110 may supply the virtual address of the sending device to the multi-protocol network device 10. For example, the multi-network gateway 110 may transfer two mappings to the multi-protocol network device 10 so that the multi-protocol network device 10 knows the actual address and virtual address of both devices. In other words, the mapping table of the multi-protocol network device 10 may be as shown in FIG. 8C. The pass through module 220 changes this source address to the virtual address used by the multi-network gateway on the second network.

In yet another embodiment, the multi-network gateway 110 may transfer the entire mapping table to the multi-protocol network device 10, but only enable the pass through function for a subset of all mappings. For example, the entire mapping table shown in FIG. 3 may be copied to the multi-protocol network device 10. In this way, the multi-protocol network device 10 is aware of all of the actual and virtual addresses. However, the mapping table may include another field which indicates which mappings the multi-protocol network device 10 is to serve as proxy for. Thus, the mapping table for the multi-protocol network device 10 may be as shown in FIG. 8A, but the active connections are the opposite of that shown in FIG. 8A. The pass through module 220 changes this source address to the virtual address retrieved from the mapping table.

Note that once the multi-protocol network device 10 accepts the mapping, the multi-network gateway 110 inactivates the mapping in its own mapping table. This may be done by marking that mapping as inactive, as shown in FIG. 8A. Further, if the multi-network gateway 110 wishes to terminate a mapping, a second message, referred to as a DeleteTrafficProxyMappingRequest, may also be used. This message contains the same information as the ConfigureTrafficProxyMappingRequest, and is used to disable the pass through function of the multi-protocol network device 10 with respect to this mapping entry.

The present system has many advantages. First, the use of multi-protocol network devices relieves the bottleneck created by all traffic having to pass through the multi-network gateway. This may improve throughput and may also eliminate a single point of failure.

Additionally, the multi-protocol network devices already exist and are deployed in networks today. Therefore, this feature may be added to existing networks through a software upgrade to the multi-protocol network devices and the multi-network gateway.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of managing a system comprising two networks comprising different network protocols, wherein there is a first network device on a first network and a second network device on a second network, the method comprising:
using a multi-network gateway to create a mapping table, wherein the mapping table comprises an entry for the first network device, which comprises a first actual address used by the first network and a first virtual address used by the second network; and an entry for the second network device, which comprises a second actual address used by the second network and a second virtual address used by the first network;
identifying, by the multi-network gateway, at least one additional device that comprises a multi-protocol network device, which has an actual address on the first network and an actual address on the second network;
transferring at least one entry of the mapping table to the multi-protocol network device;
receiving, at the multi-protocol network device, a packet from the first network device on the first network having a destination address that comprises the second virtual address that represents the second network device on the second network, updating the destination address to the second actual address based on the at least one entry and forwarding the packet on the second network.

2. The method of claim 1, wherein each entry in the mapping table comprises a function of each network device.

3. The method of claim 1, wherein the multi-protocol network device is identified by the multi-network gateway based on a Media Access Control (MAC) address received on the first network and the second network.

4. The method of claim 1, wherein the multi-protocol network device is identified by the multi-network gateway using vendor unique commands.

5. The method of claim 1, wherein the multi-protocol network device uses a source address provided by the first network device in the packet transmitted on the second network.

6. The method of claim 1, wherein the multi-protocol network device creates a virtual address, different from the first virtual address, to use as a source address in the packet transmitted on the second network.

7. The method of claim 1, wherein the multi-protocol network device uses the first virtual address as a source address in the packet transmitted on the second network.

8. The method of claim 7, wherein the multi-network gateway transfers both entries in the mapping table to the multi-protocol network device.

9. The method of claim 8, wherein the mapping table comprises additional entries, and the additional entries are not transferred to the multi-protocol network device.

10. The method of claim 8, wherein the mapping table comprises additional entries, and the additional entries are transferred to the multi-protocol network device and the multi-protocol network device only forwards packets assigned to a subset of the mapping table.

11. A system comprising a first network and a second network, comprising:
a multi-network gateway that operates on the first network and the second network; and
a multi-protocol network device that operates on the first network and the second network;
wherein the multi-network gateway is configured to:
query the first network to find network devices on the first network;
query the second network to find network devices on the second network;
create a mapping table wherein each entry in the mapping table comprises an actual address of a network device and a virtual address for the network device;
identify the multi-protocol network device; and
transmit at least one entry from the mapping table to the multi-protocol network device; and
wherein the multi-protocol network device is configured to:
receive the at least one entry from the multi-network gateway;
receive a packet from a first network device on the first network having a destination address that comprises the virtual address contained in the entry that represents a second network device on the second network;
update the destination address to the actual address based on the at least one entry; and
forward the packet on the second network.

12. The system of claim 11, wherein each entry in the mapping table comprises a function of each network device.

13. The system of claim 11, wherein the multi-protocol network device is identified by the multi-network gateway based on a Media Access Control (MAC) address received on the first network and the second network.

14. The system of claim 11, wherein the multi-protocol network device uses a source address provided by the first network device in the packet transmitted on the second network.

15. The system of claim 11, wherein the multi-protocol network device creates a virtual address, different from the virtual address in the mapping table, to use as a source address in the packet transmitted on the second network.

16. The system of claim 11, wherein the multi-protocol network device uses the virtual address in the mapping table as a source address in the packet transmitted on the second network.

17. The system of claim 16, wherein the mapping table comprises an entry for the first network device and an entry for the second network device and the multi-network gateway transfers both entries in the mapping table to the multi-protocol network device.

18. The system of claim 17, wherein the mapping table comprises additional entries, and the additional entries are not transferred by the multi-network gateway to the multi-protocol network device.

19. The system of claim 17, wherein the mapping table comprises additional entries, and the additional entries are transferred by the multi-network gateway to the multi-protocol network device and the multi-protocol network device only forwards packets assigned to a subset of the mapping table.

20. The system of claim 11, wherein the multi-protocol network device also comprises a line-powered application.
